(19) United States
(12) Patent Application Publication
(10) Pub. No.: US 2022/0105730 A1
(43) Pub. Date: Apr. 7, 2022

(54) CLEANING DEVICE, IMAGE FORMING APPARATUS, WINDING CONTROL METHOD, AND PROGRAM

(71) Applicant: Konica Minolta, Inc., Tokyo (JP)

(72) Inventors: Yohei ITO, Tokyo (JP); Hiroyuki TOKIMATSU, Tokyo (JP)

(21) Appl. No.: 17/492,129

(22) Filed: Oct. 1, 2021

(30) Foreign Application Priority Data
Oct. 7, 2020 (JP) 2020-169946

(51) Int. Cl. B41J 2/165

(52) U.S. Cl. CPC B41J 2/16544; B41J 2/16538

(57) ABSTRACT

A cleaning device includes: a cleaning member that comes into contact with a nozzle surface of a head unit that forms an image on a recording medium by an inkjet head, the cleaning member cleaning an ink remaining on the nozzle surface; a winding part that winds the cleaning member so that an unused part of the cleaning member comes in contact with the nozzle surface; and a hardware processor that controls the winding part to change a winding amount of the cleaning member according to an amount of ink to be cleaned by the cleaning member.

The entire disclosure of Japanese patent Application No. 2020-169946, filed on Oct. 7, 2020, is incorporated herein by reference in its entirety.

### BACKGROUND

### Technological Field

The present invention relates to a cleaning device, an image forming apparatus, a winding control method, and a program.

### Description of the Related Art

Conventionally, there has been known an inkjet image forming apparatus that forms (records) an image on a recording medium conveyed by a conveyance device by ejecting an ink from a plurality of nozzles provided in an inkjet head.

The inkjet head included in the inkjet image forming apparatus ejects the ink from the plurality of nozzles. Pressure is individually applied to each nozzle, and ink ejection control is performed according to an image to be recorded. An ink ejection opening of the nozzle is aligned and opened on one surface (nozzle surface) of the inkjet head facing the recording medium at the time of image formation.

In the inkjet image forming apparatus having such a configuration, if there is adhesion of foreign matter, a residue of dried and thickened ink, mixture of air bubbles, or the like on the nozzle surface, favorable ink ejection for image formation cannot be performed. Hence, head cleaning is performed to maintain an ejection state of ink favorably.

As the head cleaning, the ink in the nozzle is discharged by pressurization from a nozzle upstream side or suction from a nozzle surface side, whereby foreign matter, dried and thickened ink, mixed air bubbles, and the like are removed (purified) together with the discharged ink.

Additionally, after ink discharging as such a cleaning operation and the like, the ink remaining on the nozzle surface is cleaned (removed) by a wiping operation of moving a wiping member (cleaning member) with the wiping member abutting on the nozzle surface (see, for example, JP 2013-226804 A). In the wiping operation, a wiping member such as a wiper blade for scraping off the ink or an absorbent sheet member is used.

JP 2013-226804 A describes a technique of cleaning a face surface of a recording head with a part of a sheet-shaped member as a cleaning member, and then winding the sheet-shaped member so that an unused part of the sheet-shaped member comes into contact with the face surface of the recording head in the next cleaning. In the technique described in JP 2013-226804 A, as elapsed time from an operation of wiping off the ink adhered to the face surface of the recording head (wiping operation) is longer, the ink adhered to the sheet-shaped member smears and spreads (specifically, the width of a wiping mark gradually increases), and thus control is performed so that a winding amount of the sheet-shaped member after wiping increases.

However, in the technique described in JP 2013-226804 A, even when an amount of ink actually remaining on the nozzle surface is small, that is, even when an amount of ink wiped by the cleaning member (sheet-shaped member) is small and an amount required for winding the cleaning member is actually small, when elapsed time from the wiping operation is long, the winding amount of the sheet-shaped member after wiping is constantly increased. Therefore, there are cases where although the amount of ink actually remaining on the nozzle surface is small, the cleaning member is wound more than necessary, and in those cases, there is a problem that waste of the cleaning member occurs.

### SUMMARY

An object of the present invention is to provide a cleaning device, an image forming apparatus, and a winding control method capable of preventing occurrence of waste in a cleaning member.

To achieve the abovementioned object, according to an aspect of the present invention, a cleaning device reflecting one aspect of the present invention comprises: a cleaning member that comes into contact with a nozzle surface of a head unit that forms an image on a recording medium by an inkjet head, the cleaning member cleaning an ink remaining on the nozzle surface; a winding part that winds the cleaning member so that an unused part of the cleaning member comes in contact with the nozzle surface; and a hardware processor that controls the winding part to change a winding amount of the cleaning member according to an amount of ink to be cleaned by the cleaning member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an inkjet image forming apparatus;

FIG. 2 is a schematic diagram illustrating a configuration of a head unit;

FIG. 3 is a block diagram illustrating a main functional configuration of the inkjet image forming apparatus;

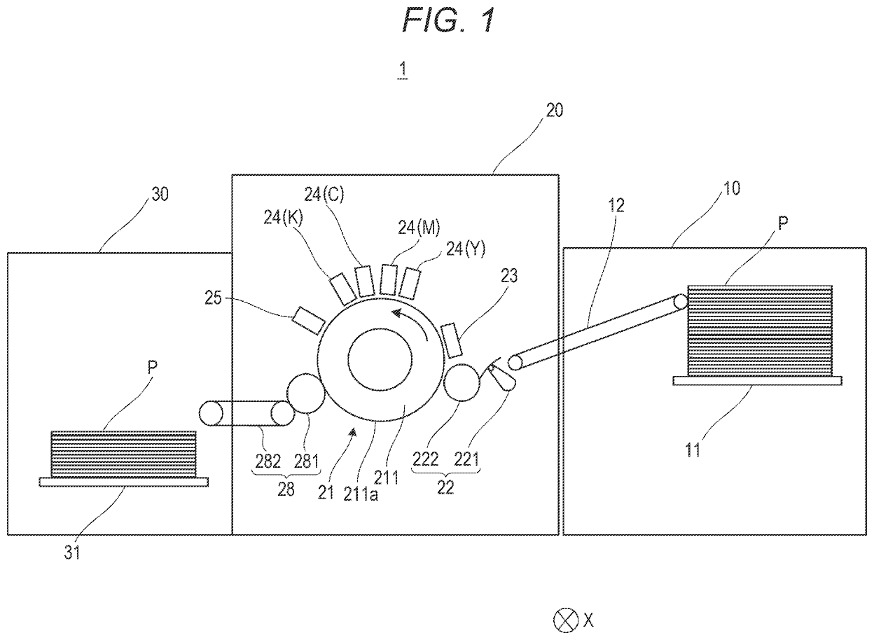

FIGS. 1A to 4D are diagrams for describing a configuration and an operation of a cleaning device;

FIGS. 5A and 5B are diagrams for describing the operation of the cleaning device according to a purge operation;

FIG. 6 is a diagram for describing the operation of the cleaning device according to a pre-cleaning operation;

FIG. 7 is a diagram for describing the operation of the cleaning device according to time of contact between a cleaning member and a nozzle surface;

FIGS. 8A and 8B are graphs for describing changes in water repellency of the nozzle surface;

FIG. 9 is a flowchart illustrating an example of a winding control operation of the inkjet image forming apparatus; and

FIG. 10 is a diagram it illustrating a, modification example of a configuration for detecting a winding amount of the cleaning member.

### DETAILED DESCRIPTION OF EMBODIMENTS

Hereinafter, one or more embodiments of the present invention will be described with reference to the drawings. However, the scope of the invention is not limited to the disclosed embodiments.

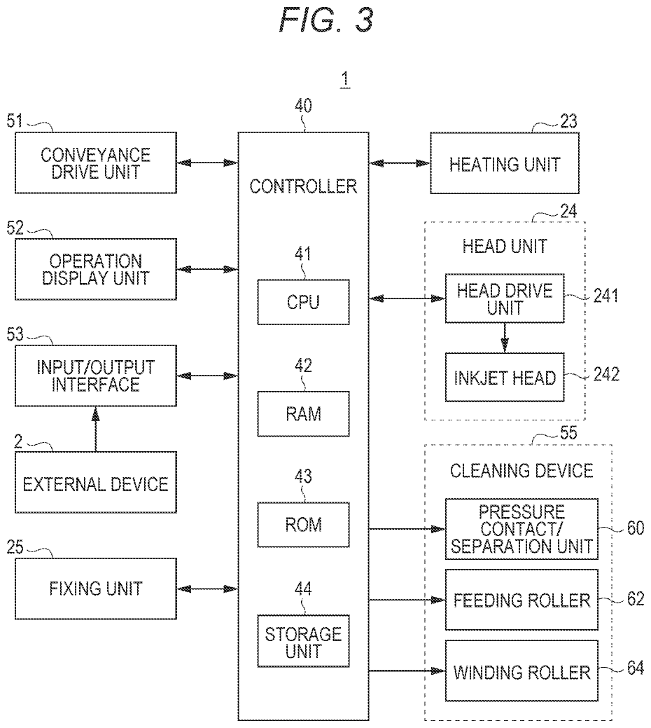

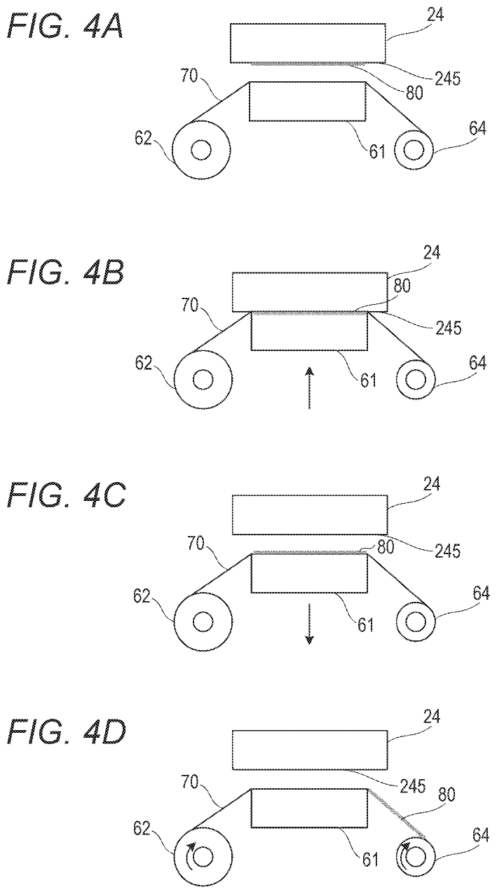

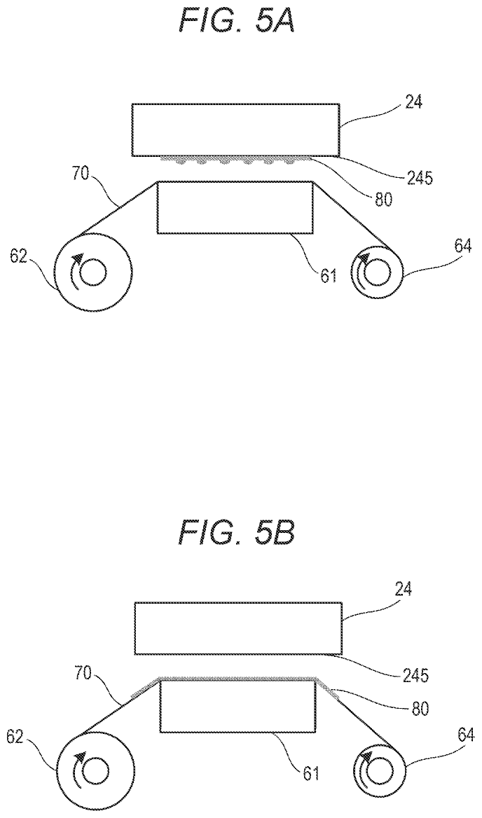

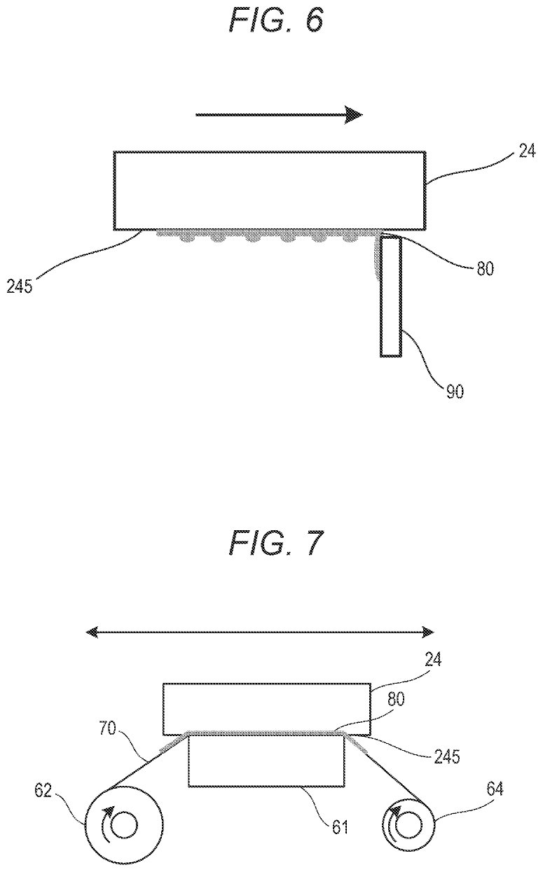

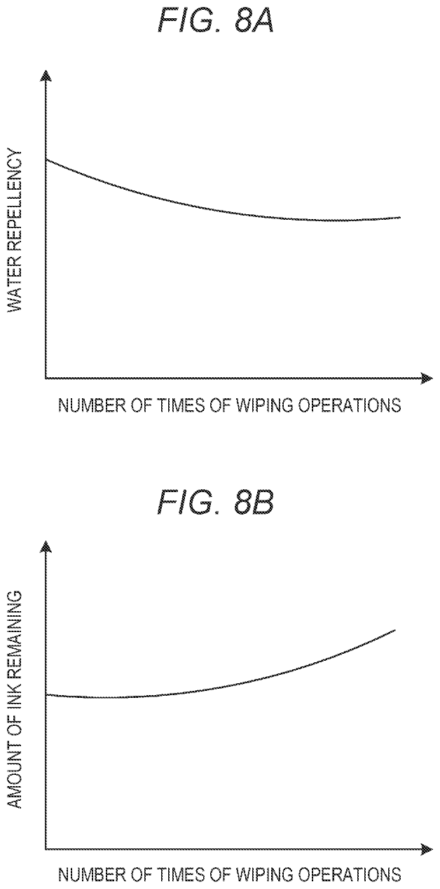

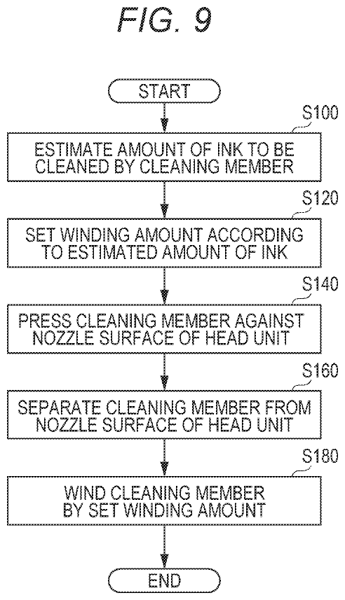

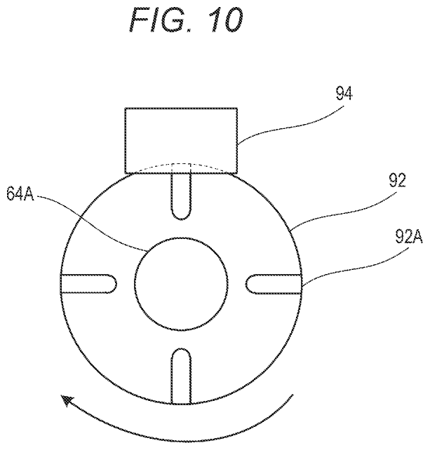

FIG. 1 is a diagram illustrating a schematic configuration of an inkjet image forming apparatus (functioning as an “image forming apparatus” of the present invention). The inkjet image forming apparatus 1 includes a paper feeding unit 10, an image forming unit 20, a paper ejecting unit 30, and a controller 40 (see FIG. 3).

Under the control of the controller 40, the inkjet image forming apparatus 1 conveys a recording medium P stored in the paper feeding unit 10 to the image forming unit 20, forms an image on the recording medium Pin the image forming unit 20, and conveys the recording medium P on which the image is formed to the paper ejecting unit 30. As the recording medium P, various media to which an ink 80 that has landed on a surface can be fixed such as a cloth and a sheet-shaped resin can be used in addition to paper such as plain paper and coated paper.

The paper feeding unit 10 includes a paper feeding tray 11 that stores the recording medium P, and a medium feeding unit 12 that conveys and supplies the recording medium P from the paper feeding tray 11 to the image forming unit 20, The medium feeding unit 12 includes an annular belt whose inside is supported by two rollers and conveys the recording medium P from the paper feeding tray 11 to the image forming unit 20 by rotating the rollers with the recording medium P placed on the belt.

The image forming unit 20 includes a conveyance unit 21, a transfer unit 22, a healing unit 23, a head unit 24, a fixing unit 25, a delivery unit 28, and the like.

The conveyance unit 21 holds the recording medium P placed on a conveyance surface 211a. (placement surface) of a cylindrical conveyance drum 211 and performs a conveyance operation of conveying the recording medium P on the conveyance drum 211 in a conveyance direction (Y direction) by the conveyance drum 211 rotating and moving around a rotary shaft (cylindrical shaft) extending in an X direction (direction perpendicular to the paper surface of FIG. 1).

The conveyance drum 211 includes a claw part and a suction part (not illustrated) for holding the recording medium P on the conveyance surface 211a. The recording medium P is held on the conveyance surface 211a by the end of the recording medium P being pressed by the claw part and being sucked to the conveyance surface 211a by the suction part. The conveyance unit 21 is connected to a conveyance drum motor (not illustrated) for rotating the conveyance drum 211. The conveyance drum 211 rotates by an angle proportional to a rotation amount of the conveyance drum motor.

The transfer unit 22 delivers the recording medium P conveyed by the medium feeding unit 12 of the paper feeding unit 10 to the conveyance unit 21. The transfer unit 22 is provided at a position between the medium feeding unit 12 of the paper feeding unit 10 and the conveyance unit 21, holds and picks up one end of the recording medium P conveyed from the medium feeding unit 12 by a swing arm unit 221, and delivers the recording medium P to the conveyance unit 21 via a transfer drum 222.

The heating unit 23 is provided between an arrangement position of the transfer drum. 222 and an arrangement position of the head unit 24 and heats the recording medium P so that the recording medium P conveyed by the conveyance unit 21 reaches a temperature within a predetermined temperature range. The heating unit 23 includes, for example, an infrared heater or the like, and energizes the infrared heater on the basis of a control signal supplied from the controller 40 to cause the infrared heater to generate heat.

The head unit 24 forms an image by ejecting the ink 80 to the recording medium P from an ink ejection opening (nozzle opening) provided on a nozzle surface 245 (ink ejection surface) facing the conveyance surface 211a of the conveyance drum 211 at an appropriate timing according to the rotation of the conveyance drum 211 holding the recording medium P. The head unit 24 is arranged so that the nozzle surface 245 and the conveyance surface 211a are separated from each other by a predetermined distance.

In the inkjet image forming apparatus 1 according to the present embodiment, four head units 24 corresponding to the ink 80 of four colors of yellow CY), magenta (M), cyan (C), and black (K) are arranged so as to be arranged at predetermined intervals in the order of Y, M, C, and K colors from an upstream side in the conveyance direction of the recording medium P.

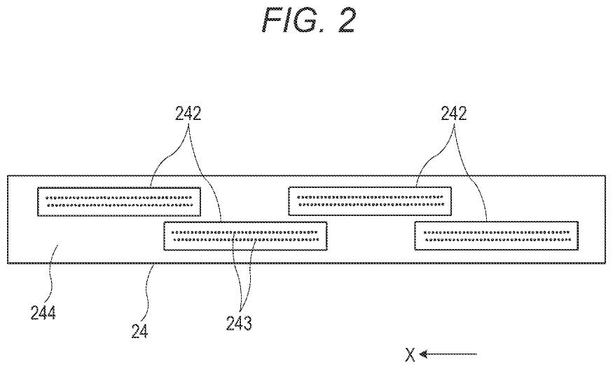

FIG. 2 is a schematic diagram illustrating a configuration of the head unit 24. Here, the nozzle surface 245 of the head unit 24 facing the conveyance surface 211a of the conveyance drum 211 is illustrated.

The head unit 24 includes four inkjet heads 242 attached to an attachment member 244. Each of the inkjet heads 242 is provided with a plurality of image forming elements (recording elements) each having a pressure chamber that stores the ink 80, a piezoelectric element provided on a wall surface of the pressure chamber, and a nozzle 243. When a drive signal that deforms the piezoelectric element is input in the image forming element, the pressure chamber is deformed by the deformation of the piezoelectric: element, pressure in the pressure chamber changes, and the ink 80 is ejected from the nozzle 243 communicating with the pressure chamber.

In the inkjet head 242, two nozzle rows including the nozzles 243 arranged at equal intervals in a direction (a, direction orthogonal to the conveyance direction, that is, the X direction in the present embodiment) intersecting the conveyance direction of the recording medium P are formed. These two nozzle rows are provided so that arrangement positions of the nozzles 243 are shifted from each other in the X direction by half an arrangement interval of the nozzles 243 in each nozzle row.

The four inkjet heads 242 are arranged in a zigzag pattern so that the arrangement ranges of the nozzle rows in the X direction are connected continuously. The arrangement range of the nozzles 243 included in the head unit 24 in the X direction covers a width in the X direction of an area where an image is formed on the recording medium P conveyed by the conveyance unit 21, and a position of the head unit 24 is fixed with respect to the rotary shaft of the conveyance drum 211 at the time of image formation. That is, the head unit 24 includes a line head capable of ejecting the ink 80 over an image formable width in the X direction with respect to the recording medium P. The inkjet image forming apparatus 1 is an inkjet image forming apparatus of a single-pass type.

Note that the number of nozzle rows included in the inkjet head 242 may be one or three or more instead of two. Additionally, the number of inkjet heads 242 included in the head unit 24 may be three or less or five or more instead of four.

As the ink 80 ejected from the nozzle 243 of the image forming element, ink containing a pigment, for example, a white ink containing titanium dioxide or the like as a pigment is used. Additionally, as the ink 80 ejected from the nozzle 243 of the image forming element, a gel ink containing a gelling agent, having a property of changing in phase to a gel-like state or a sol-like state depending on a temperature, and curing by irradiation with energy rays such as Ultraviolet rays is used. In the present embodiment, as the ink 80 ejected from the nozzle 243 of the image forming element, a gel ink containing a pigment is used.

The head unit 24 includes an ink heating unit (not illustrated) that heats the ink 80 stored in the head unit 24. The ink heating unit operates under the control of the controller 40 and heats the ink 80 to a temperature at which the ink 80 becomes sot-like.

The inkjet head 242 ejects the ink 80 that has been heated and has become sol-tike. When the ink 80 is ejected onto the recording medium P, ink droplets land on the recording medium P and then naturally cool, whereby the ink 80 quickly becomes gel-like and solidifies on the recording medium P.

The fixing unit 25 includes a light emitting unit arranged over a width of the conveyance unit 21 in the X direction, and irradiates the recording medium P placed on the conveyance unit 21 with energy rays such as ultraviolet rays from the light emitting unit to cure and the ink 80 (gel ink) ejected on the recording medium P. The light emitting unit of the fixing unit 25 is arranged to face the conveyance surface 211a between the arrangement position of the head unit 24 and an arrangement position of a transfer drum 281 of the delivery unit 28 in the conveyance direction.

The delivery unit 28 includes the cylindrical transfer drum 281 that transfers the recording medium P from the conveyance unit 21 to a belt loop 282 and the belt loop 282 including an annular belt whose inside is supported by two rollers. The delivery unit 28 conveys, by the belt loop 282, the recording medium P transferred by the transfer drum 281 from the conveyance unit 21 onto the belt loop 282 and sends the recording medium P to the paper ejecting unit 30.

The paper ejecting unit 30 includes a plate-like paper ejecting tray 31 on which the recording medium P sent from the image forming unit 20 by the delivery unit 28 is placed.

In the inkjet image forming apparatus 1, if there is adhesion of foreign matter, a residue of the dried and thickened ink 80, mixture of air bubbles, or the like on the nozzle surface 245 on which the nozzle 243 that ejects the ink 80 is formed, favorable ink ejection for image formation cannot be performed. Hence, head cleaning is performed to maintain an ejection state of the ink 80 favorably.

As the head cleaning, a purge operation of forcibly discharging the ink 80 in the nozzle by pressurization from the nozzle upstream side or suction from a side of the nozzle surface 245 is performed to remove (purify) foreign matter, the dried and thickened ink 80, mixed air bubbles, and the like together with the discharged ink 80.

Additionally, after ink discharging as such a cleaning operation, the ink 80 remaining on the nozzle surface 245 is cleaned by the wiping operation of moving the nozzle surface 245 with the cleaning member 70 abutting on the nozzle surface 245. In the wiping operation, an absorbent sponge member or cloth member (for example, a cloth or nonwoven fabric) or the cleaning member 70 such as a rubber blade (blade member) that scrapes off the ink 80 is used.

FIG. 3 is a block diagram illustrating a main functional configuration of the inkjet image forming apparatus E The inkjet image forming apparatus 1 includes the heating unit 23, a head drive unit 241, the inkjet, head 242, the fixing unit 25, the controller 40, a conveyance drive unit 51, an operation display unit 52, an input/output interface 53, and a cleaning device 55.

The head drive unit 241 supplies a drive signal that deforms the piezoelectric element according to image data at an appropriate timing to the image forming element of the inkjet head 242, whereby an amount of the ink 80 corresponding to a pixel value of the image data is ejected from the nozzle 243 of the inkjet head 242.

The controller 40 includes a central processing unit (CPU) 41, a random access memory (RAM) 42, a read only memory (ROM) 43, and a storage unit 44.

The CPU 41 reads various control programs and setting data stored in the ROM 43, stores the control programs and the setting data in the RAM 42, and executes the programs to perform various kinds of arithmetic processing. Additionally, the CPU 41 controls an overall operation of the inkjet image forming apparatus 1.

The RAM 42 provides a working memory space to the CPU 41 and stores temporary data. The RAM 42 may include a nonvolatile memory.

The ROM 43 stores the various control programs executed by the CPU 41, setting data, and the like. Note that a rewritable nonvolatile memory such as an electrically erasable programmable read only memory (EEPROM) and a flash memory may be used instead of the ROM 43.

The storage unit 44 stores a print job (image forming command) input and image data related to the print job, and the like input from an external device 2 via the input/output interface 53. Among the stored data, the print job includes, in addition to information specifying the image data related to the image to be formed, information (for example, size and thickness of the recording medium P) related to the type of the recording medium P on which the image is to be formed. As the storage unit 44, for example, a hard disk drive (HDD) is used, and a dynamic random access memory (DRAM) or the like may be used in combination therewith.

The conveyance drive unit 51 supplies a drive signal to the conveyance drum motor of the conveyance drum 211 on the basis of a control signal supplied from the controller 40 and rotates the conveyance drum 211 at a predetermined speed and timing.

Additionally, the conveyance drive unit 51 supplies a drive signal to a motor for operating the medium feeding unit 12, the transfer unit 22, and the delivery unit 28 on the basis of a control signal supplied from the controller 40 and causes the recording medium. P to be supplied to the conveyance unit 21 and discharged from the conveyance unit 21.

The operation display unit 52 includes a display device such as a liquid crystal display or an organic electroluminescence (EL) display, and input devices such as operation keys and a touch panel arranged so as to be superimposed on a screen of the display device. The operation display unit 52 displays various types of information on the display device, converts a user's input operation on the input device into an operation signal, and outputs the operation signal to the controller 40.

The input/output interface 53 mediates data transmission and reception of data between the external device 2 and the controller 40. The input/output interface 53 includes, for example, any of various serial interfaces and various parallel interfaces or a combination thereof.

The external device 2 is, for example, a personal computer and supplies a print job, image data, and the like to the controller 40 via the input/output interface 53.

The cleaning device 55 cleans the ink 80 remaining on the nozzle surface 245 by the wiping operation of moving the head unit 24 with the cleaning member 70 (see FIGS. 4A to 4D) abutting on the nozzle surface 245 of the head unit 24. In the present embodiment, an absorbent cloth member (for example, a cloth or nonwoven fabric) is used as the cleaning member 70.

FIGS. 4A to 4D are diagrams for describing a configuration and operation of the cleaning device 55. As illustrated in FIGS. 4A to 4D, the cleaning device 55 includes a pressure contact/separation unit 60, a feeding roller 62, a winding roller 64 (functioning as a “winding part” of the present invention), and the cleaning member 70 stretched between the feeding roller 62 and the winding roller 64. Note that the controller 40 and the cleaning device 55 function as a “cleaning device” of the present invention.

The feeding roller 62 feeds the wound cleaning member 70 while rotating under the control of the controller 40. The winding roller 64 winds the cleaning member 70 fed by the feeding roller 62 while rotating under the control of the controller 40.

A backup member 61 that supports the cleaning member 70 from below is provided between the feeding roller 62 and the winding roller 64. The backup member 61 is, for example, a flat plate-like member including porous bodies (for example, porous ceramic and liquid permeable resin) through which air can pass. The backup member 61 is parallel to the nozzle surface 245 of the head unit 24 and is abutted on the inside of the cleaning member 70 to support so that the cleaning member 70 is parallel to the nozzle surface 245. The pressure contact/separation unit 60 has a known configuration and moves the backup member 61 upward, thereby bringing the cleaning member 70 into pressure contact with the nozzle surface 245 of the head unit 24 or moves the backup member 61 downward, thereby separating the cleaning member 70 from the nozzle surface 245 of the head unit 24 under the control of the controller 40.

FIG. 4A illustrates a state before cleaning by the cleaning device 55 is performed. In this state, the controller 40 controls the pressure contact/separation unit 60 to move the backup member 61 downward, thereby separating the cleaning member 70 from the nozzle surface 245 of the head twit 24. The ink 80 remains on the nozzle surface 245 of the head unit 24.

FIG. 4B illustrates a state in which the cleaning by the cleaning device 55 is being performed. In this state, the controller 40 controls the pressure contact/separation unit 60 to move the backup member 61 upward, thereby bringing the cleaning member 70 into pressure contact with the nozzle surface 245 of the head unit 24. As a result, the ink 80 remaining on the nozzle surface 245 of the head unit 24 is subjected to liquid absorption (adsorption) and cleaning by the cleaning member 70.

In the present embodiment, the ink 80 remaining on the nozzle surface 245 is cleaned by the wiping operation (abrasion operation) of moving the head unit 24 with the cleaning member 70 abutting on the nozzle surface 245. Note that the wiping operation is not necessarily required.

FIG. 4C illustrates a state after the cleaning by the cleaning device 55 is performed. In this state, the controller 40 controls the pressure contact/separation unit 60 to move the backup member 61 downward, thereby separating the cleaning member 70 from the nozzle surface 245 of the head unit 24.

FIG. 4D illustrates a state in which the cleaning member 70 is wound so that an unused part of the cleaning member 70 comes into contact with the nozzle surface 245 of the head unit 24 in the next cleaning by the cleaning device 55. The controller 40 causes the feeding roller 62 and the winding roller 64 to feed and wind the wound cleaning member 70. Here, a winding amount of the cleaning member 70 is longer than a length of the head unit 24 in a winding direction of the cleaning member 70.

In the present embodiment, a stepping motor is used as a driving motor that rotationally drives the feeding roller 62 and the winding roller 64. The controller 40 detects the winding amount of the cleaning member 70 on the basis of the number of drive pulses output to the stepping motor.

Incidentally, in a conventional technique (technique described in JP 2013-226804 A), even when the amount of ink actually remaining on the nozzle surface is small, that is, even when the amount of the ink wiped by the cleaning member (sheet-shaped member) is small and the amount required for winding the cleaning member is actually small, when the elapsed time from the wiping operation is long, the winding amount of the sheet-shaped member after wiping is constantly increased. Therefore, there are cases where although the amount of ink actually remaining on the nozzle surface is small, the cleaning member is wound more than necessary, and in those cases, there is a problem that waste of the cleaning member occurs.

Hence, in the present embodiment, for the purpose of reducing the occurrence of waste in the cleaning member, the controller 40 controls the winding roller 64 so as to change the winding amount of the cleaning member 70 according to an amount of ink to be cleaned by the cleaning member 70. Specifically, the controller 40 estimates the amount of ink to be cleaned by the cleaning member 70 and controls the winding roller 64 so as to decrease the winding amount of the cleaning member 70 as the estimated amount of ink decreases.

For example, the controller 40 changes the winding amount of the cleaning member 70 according to whether the purge operation of forcibly discharging the ink 80 in the inkjet head 242 is executed before cleaning by the cleaning member 70.

FIG. 5A illustrates a state of the nozzle surface 245 of the head unit 24 after the purge operation of forcibly discharging the ink 80 in the inkjet head 242 is executed. As shown in FIG. 5A, after the execution of the purge operation, an amount of the ink 80 remaining on the nozzle surface 245 increases. Therefore, as shown in FIG. 5B, an amount of the ink 80 subjected to liquid absorption (adsorption) and cleaning by the cleaning member 70 increases, the ink 80 spreads over a wide range of the cleaning member 70, and as a result, the winding amount of the cleaning member 70 needs to be increased.

Hence, in the present embodiment, when the purge operation of forcibly discharging the ink 80 in the inkjet head 242 is executed before the cleaning by the cleaning member 70, the controller 40 increases the winding amount of the cleaning member 70 as compared with when the purge operation is not executed.

Additionally, the controller 40 changes the winding amount of the cleaning member 70 according to an image forming condition (for example, coverage (printing rate) of the image to be formed, image forming time (printing nine), and the like) related to image formation of the head unit 24. When the coverage is large or the image forming time is long, it is estimated that an amount of ink mist generated is large, and the amount of the ink 80 adhering to and remaining on the nozzle surface 245 increases. Therefore, the amount of the ink 80 subjected to liquid absorption (adsorption) and cleaning by the cleaning member 70 increases, the ink 80 spreads over a wide range of the cleaning member 70, and as a result, the winding amount of the cleaning member 70 needs to be increased.

Hence, in the present embodiment, when the amount of ink mist generated that is estimated according to the image forming condition related to image formation of the head unit 24 is large, the controller 40 increases the winding amount of the cleaning member 70 as compared with when the amount of ink mist generated is not large.

Additionally, the controller 40 changes the winding amount of the cleaning member 70 according to an inclination angle of the nozzle surface 245 of the head unit 24 with respect to a horizontal direction. When the inclination angle of the nozzle surface 245 is large, for example, when the purge operation is executed, the amount of the ink 80 adhering to and remaining on the nozzle surface 245 (specifically, the top plate region of the nozzle surface 245 where the inkjet head 242 is not provided) without the forcibly discharged ink falling from the head unit 24 increases. Therefore, the amount of the ink 80 subjected to liquid absorption (adsorption) and cleaning by the cleaning member 70 increases, the ink 80 spreads over a wide range of the cleaning member 70, and as a result, the winding amount of the cleaning member 70 needs to be increased.

Hence, in the present embodiment, when the inclination angle of the nozzle surface 245 of the head unit 24 is large; the controller 40 increases the winding amount of the cleaning member 70 as compared with when the inclination angle is not large.

Additionally, the controller 40 changes the winding amount of the cleaning member 70 according to whether a pre-cleaning operation of precleaning the ink 80 remaining on the nozzle surface 245 of the head unit 24 is executed before the cleaning by the cleaning member 70.

FIG. 6 illustrates a state in which the pre-cleaning operation of precleaning the ink 80 remaining on the nozzle surface 245 of the head unit 24 by a pre-cleaning member 90 is being executed. As illustrated in FIG. 6, the ink 80 remaining on the nozzle surface 245 is scraped off and precleaned by a non-contact blade as the pre-cleaning member 90. Note that the pre-cleaning member 90 may be an absorbent sponge member.

After the pre-cleaning operation is executed, the amount of the ink 80 remaining on the nozzle surface 245 decreases. Therefore, thereafter, the amount of the ink 80 subjected to liquid absorption (adsorption) and cleaning by the cleaning member 70 decreases, the ink 80 does not spread over a wide range of the cleaning member 70, and as a result, the winding amount of the cleaning member 70 needs to be decreased.

Hence, in the present embodiment, when the pre-cleaning operation of precleaning the ink 80 remaining on the nozzle surface 245 of the head unit 24 is executed before the cleaning by the cleaning member 70, the controller 40 decreases the winding amount of the cleaning member 70 as compared with when the pre-cleaning operation is not executed.

Additionally, the controller 40 changes the winding amount of the cleaning member 70 according to time of contact between the cleaning member 70 and the nozzle surface 245 when cleaning is performed by the cleaning member 70.

FIG. 7 illustrates a state in which the ink 80 remaining on the nozzle surface 245 is cleaned by the wiping operation (abrasion operation) of moving the head unit 24 with the cleaning member 70 abutting on the nozzle surface 245. Here, it is assumed that the inkjet image forming apparatus 1 includes a plurality of cleaning modes having different time during which the cleaning member 70 abuts on the nozzle surface 245. In this case, if the time during which the cleaning member 70 abuts on the nozzle surface 245 is long, a large amount of the ink 80 is drawn out front the nozzle 243 by the capillary force of the cleaning member 70 (cloth member), and the amount of the ink 80 remaining on the nozzle surface 245 increases. Therefore, the amount of the ink 80 subjected to liquid absorption (adsorption) and cleaning by the cleaning member 70 increases, the ink 80 spreads Over a wide range of the cleaning member 70, and as a result, the winding amount of the cleaning member 70 needs to be increased.

Hence, in the present embodiment, in a case where the time of contact between the cleaning member 70 and the nozzle surface 245 when cleaning is performed by the cleaning member 70 is long, the controller 40 increases the winding amount of the cleaning member 70 as compared with when the time of contact is not long.

Additionally, the controller 40 changes the winding amount of the cleaning member 70 according to water repellency of the nozzle surface 245. FIG. 8A illustrates a relationship between the number of times of the wiping operations (abrasion operations) of moving the head unit 24 with the cleaning member 70 abutting on the nozzle surface 245 and the water repellency of the nozzle surface 245. FIG. 8B illustrates a relationship between the number of times of the wiping operations and the amount of the ink 80 remaining on the nozzle surface 245.

As illustrated in FIGS. 8A and 8B, the water repellency of the nozzle surface 245 decreases as the number of times of the wiping operations increases and the amount of the ink 80 remaining on the nozzle surface 245 increases. Therefore, the amount of the ink 80 subjected to liquid absorption (adsorption) and cleaning by the cleaning member 70 increases, the ink 80 spreads over a wide range of the cleaning member 70, and as a result, the winding amount of the cleaning member 70 needs to be increased.

Hence, in the present embodiment, when the water repellency of the nozzle surface 245 decreases, the controller 40 increases the winding amount of the cleaning member 70 as compared with when the water repellency does not decrease.

Next, a winding control operation of the inkjet image forming apparatus 1 will be described. FIG. 9 is a flowchart illustrating an example of the winding control operation of the inkjet image forming apparatus (corresponding to a “winding control method” of the present invention). Step S100 in FIG. 9 starts when an instruction to execute head cleaning is issued in the inkjet image forming apparatus 1.

First, the controller 40 estimates the amount of ink to be cleaned by the cleaning member 70 (step S100).

Next, the controller 40 sets the winding amount of the cleaning member 70 according to the estimated amount of ink (step S120).

Next, the controller 40 controls the pressure contact/separation unit 60 to move the backup member 61 upward, thereby pressing the cleaning member 70 against the nozzle surface 245 of the head unit 24 (step S140). As a result, the ink 80 remaining on the nozzle surface 245 of the head unit 24 is subjected to liquid absorption (adsorption) and cleaning by the cleaning member 70.

Next, the controller 40 controls the pressure contact/separation unit 60 to move the backup member 61 downward, thereby separating the cleaning member 70 from the nozzle surface 245 of the head unit 24 (step S160).

Finally, the controller 40 causes the feeding roller 62 and the winding roller 64 to feed and wind the cleaning member 70 by the winding amount set in step S120 so that the unused part of the cleaning member 70 comes into contact with the nozzle surface 245 of the head unit 24 in the next cleaning by the cleaning device 55 (step S180). When the processing of step S180 is completed, the inkjet image forming apparatus 1 ends the winding control operation.

As described above in detail, the inkjet image forming apparatus 1 (image forming apparatus) according to the present embodiment includes the cleaning member 70, the winding roller 64 (winding part), and the controller 40. The cleaning member 70 comes into contact with the nozzle surface 245 of the head unit 24 that forms an image on the recording medium P by the inkjet head 242 that ejects ink from the plurality of nozzles 243, and the cleaning member 70 cleans the ink 80 remaining on the nozzle surface 245. The winding roller 64 (winding part) winds the cleaning member 70 so that the unused part of the cleaning member 70 comes into contact with the nozzle surface 245. The controller 40 controls the winding roller 64 to change the winding amount of the cleaning member 70 according to the amount of ink to be cleaned by the cleaning member 70.

According to the present embodiment configured as described above, control is performed so that the winding amount of the cleaning member 70 is changed according to the amount of ink to be cleaned by the cleaning member 70. For example, when an amount of ink actually remaining on the nozzle surface 245 is small, that is, when the amount of ink to be cleaned by the cleaning member 70 is small and an amount necessary for winding the cleaning member 70 is actually small, the winding amount of the cleaning member 70 after the cleaning is controlled to be small even if elapsed time from the cleaning operation is long. As a result, it is possible to prevent the cleaning member 70 from being wound more than necessary even though the amount of ink actually remaining on the nozzle surface 245 is small, and eventually, it is possible to prevent waste of the cleaning member 70 from occurring.

Note that in the above-described embodiment, an example in which the winding amount of the cleaning member 70 is detected on the basis of the number of drive pulses output to the stepping motor that rotationally drives the feeding roller 62 and the winding roller 64 has been described, but the present invention is not limited thereto. For example, as illustrated in FIG. 10, a rotating body 92 (disc) in which cutout parts 92A (slits) are formed may be provided in a rotary shaft 64A of the winding roller 64. The rotating body 92 rotates in conjunction with the rotation of the winding roller 64. Then, a non-contact type reflective photosensor 94 detects the number of times of passages (that is, the rotation amount) of the cutout part 92A formed in the rotating body 92 according to the rotation of the rotating body 92, and outputs a result of the detection to the controller 40. The controller 40 detects the winding amount of the cleaning member 70 on the basis of the result of the detection output from the reflective photosensor 94.

Additionally, in the above-described embodiment, the inkjet image forming apparatus 1 of a single pass type has been described as an example, but the present invention may be applied to an inkjet image forming apparatus that records an image while scanning a head unit. Additionally, the present invention may be applied to an inkjet image forming apparatus in which a head unit is provided with a single nozzle.

Although embodiments of the present invention have been described and illustrated in detail, the disclosed embodiments are made for purposes of illustration and example only and not limitation. That is, the present invention can be implemented in various forms, without departing from the gist or the main features thereof. The scope of the present invention should be interpreted by terms of the appended

What is claimed is:

1. A cleaning device comprising:
a cleaning member that comes into contact with a nozzle surface of a head unit that forms an image on a recording medium by an inkjet head, the cleaning member cleaning an ink remaining on the nozzle surface;
a winding part that winds the cleaning member so that an unused part of the cleaning member comes in contact with the nozzle surface; and
a hardware processor that controls the winding part to change a winding amount of the cleaning member according to an amount of ink to be cleaned by the cleaning member.

2. The cleaning device according to claim 1, wherein
the hardware processor decreases the winding amount of the cleaning member as the amount of ink to be cleaned decreases.

3. The cleaning device according to claim 1, wherein
the hardware processor changes the winding amount of the cleaning member according to whether a purge operation of forcibly discharging ilk in the inkjet head is executed before cleaning by the cleaning member.

4. The cleaning device according to claim 1, wherein
the hardware processor changes the winding amount of the cleaning member according to an image forming condition related to image formation of the head unit.

5. The cleaning device according to claim 1, wherein
the hardware processor changes the winding amount of the cleaning member according to an inclination angle of the nozzle surface with respect to a horizontal direction.

6. The cleaning device according to claim 1, wherein
the hardware processor changes the winding amount of the cleaning member according to whether a pre-cleaning operation of precleaning the ink remaining on the nozzle surface is executed before the cleaning by the cleaning member.

7. The cleaning device according to claim 1, wherein
the hardware processor changes the winding amount of the cleaning member according to time of contact between the cleaning member and the nozzle surface when cleaning is performed by the cleaning member.

8. The cleaning device according to claim 1, wherein
the hardware processor changes the winding amount of the cleaning member according to water repellency of the nozzle surface.

9. The cleaning device according to claim 1, wherein
the winding amount of the cleaning member is longer than a length of the head unit in a winding direction of the cleaning member.

10. The cleaning device according to claim 1, wherein
the winding part winds the cleaning member while rotating, and
the hardware processor detects the winding amount of the cleaning member on the basis of the number of drive pulses output to a stepping motor that rotationally drives the winding part.

11. The cleaning device according to claim 1, wherein
the winding part winds the cleaning member while rotating,
a rotating body in which a cutout part is formed is provided on a rotary shaft of the winding part, and
the hardware processor detects the winding amount of the cleaning member on the basis of a rotation amount of the cutout part detected according to rotation of the rotating body.

12. The cleaning device according to claim 1, wherein
the cleaning member is a cloth member.

13. An image forming apparatus comprising:
the cleaning device according to claim 1; and
the head unit.

14. A winding control method of a cleaning device including
a cleaning member that comes into contact with a nozzle surface of a head unit that forms an image on a recording medium by an inkjet head, the cleaning member cleaning an ink remaining on the nozzle surface and
a winding part that winds the cleaning member so that an unused part of the cleaning member comes in contact with the nozzle surface, the winding control method comprising:
performing control of changing a winding amount of the cleaning member according to an amount of ink to be cleaned by the cleaning member.

15. A non-transitory recording medium storing a computer readable program causing a computer to execute changing a winding amount of a cleaning member according to an amount of ink to be cleaned by the cleaning member.
